(19) United States
(12) Patent Application Publication
(10) Pub. No.: US 2013/0159990 A1
(43) Pub. Date: Jun. 20, 2013

(54) UPDATING FIRMWARE USING A MOBILE COMMUNICATION DEVICE

(71) Applicants: Patrick Joseph Bohrer, Austin, TX (US); Ahmed Gheith, Austin, TX (US)

(72) Inventors: Patrick Joseph Bohrer, Austin, TX (US); Ahmed Gheith, Austin, TX (US)

(73) Assignee: INTERNATIONAL BUSINESS MACHINES CORPORATION, Armonk, NY (US)

(21) Appl. No.: 13/328,858

(22) Filed: Dec. 16, 2011

(51) Int. Cl. G06F 9/44

(52) U.S. Cl. 717/173; 717/172

(57) ABSTRACT

A method, system, and computer program product for updating firmware using a mobile communication device are provided in the illustrative embodiments. At the mobile communication device from a data processing system that includes the firmware, a current version information of the firmware is received. At the mobile communication device, an update of the firmware is stored on a data storage associated with the mobile communication device. From the mobile communication device, the data processing system is instructed to reboot using the update stored on the data storage associated with the mobile communication device.

### TECHNICAL FIELD

The present invention relates generally to a computer implemented method, system, and computer program product for updating the firmware of a data processing system. More particularly, the present invention relates to a computer implemented method, system, and computer program product for updating the firmware of the data processing system using a mobile communication device (mobile device).

### BACKGROUND

### Description of the Related Art

Data processing systems include firmware. Firmware has to be updated from time to time, such as, for example, to correct an error in a previous version of the firmware, or to support a new feature.

Different data processing systems can include different firmware, different versions of the same firmware, or a combination thereof. Firmware updates are available from a variety of sources that are accessible over a data network.

Applying a firmware update involves specific installation procedure. Different firmware, or even different versions of the same firmware, can require different installation procedures. Firmware update requires a reboot of the data processing system to take effect.

### SUMMARY

The illustrative embodiments provide a method, system, and computer program product for updating firmware using a mobile communication device. An embodiment receives, at the mobile communication device from a data processing system that includes the firmware, a current version information of the firmware. The embodiment stores, at the mobile communication device, an update of the firmware on a data storage associated with the mobile communication device. The embodiment instructs, from the mobile communication device, the data processing system to reboot using the update stored on the data storage associated with the mobile communication device.

### BRIEF DESCRIPTION OF THE SEVERAL VIEWS OF THE DRAWINGS

The novel features believed characteristic of the embodiments are set forth in the appended claims. The invention itself, however, as well as a preferred mode of use, further objectives and advantages thereof, will best be understood by reference to the following detailed description of an illustrative embodiment when read in conjunction with the accompanying drawings, wherein:

FIG. 1 depicts a pictorial representation of a network of data processing systems in which illustrative embodiments may be implemented;

FIG. 2 depicts a block diagram of a data processing system in which illustrative embodiments may be implemented;

FIG. 3 depicts an example process of receiving information about a system's firmware using a mobile communication device in accordance with an illustrative embodiment;

FIG. 4 depicts a block diagram of a process of using a mobile communication device for updating firmware in accordance with an illustrative embodiment;

FIG. 5 depicts a block diagram of using a mobile communication device for updating firmware in a data processing system in accordance with an illustrative embodiment;

FIG. 6 depicts a block diagram of applying a firmware update using a mobile communication device in accordance with an illustrative embodiment; and

FIG. 7 depicts a flowchart of a process for updating firmware using a mobile communication device in accordance with an illustrative embodiment.

### DETAILED DESCRIPTION

One of the system administration tasks is to keep the firmware up-to-date on the various data processing systems under administration. Typically, for each firmware update on each data processing system, a firmware update is downloaded from a server, and stored on a data storage medium, such as a CD-ROM or flash-memory, that can be used as a boot medium. A boot medium is a data storage medium that stores the data using which a data processing system can be booted.

The system administrator obtains and consults the installation procedure for the firmware update, and applies the update by following the steps of the procedure. The data processing system is then rebooted from the boot medium that stores the firmware update.

Illustrative embodiments recognize that the above described process of firmware update is inefficient for requiring an administrator's time and knowledge for each application of firmware update. In a typical data processing environment, such as a data center, the number of data processing systems requiring firmware updates can be large enough to occupy an administrator's entire time, away from other business critical system administration tasks.

The illustrative embodiments recognize additional problems where some of the firmware update tasks are automated. For example, some data processing systems include a management module that can, among other activities, automatically detect a firmware's version and find an update there for. However, the illustrative embodiments recognize that often, the management module is restricted from communicating over networks for security reasons. Consequently, even when the management module is configurable to find a firmware update, the management module may not be able to communicate with the server that provides the update, such as a system manufacturer's website accessible over the Internet.

The illustrative embodiments further recognize that even when a management module can find and receive a firmware update, automatic downloading and applying of the firmware update is not desirable in most data processing environments. As an example, such an automatic download may download malicious software into the data processing environment. As another example, automatic application of the firmware update may cause the system to reboot while a business critical process is executing there on. Accordingly, an administrator must still download the update, store the update to a boot medium, locate the installation procedure, perform the installation process, and reboot the system from the boot medium.

The illustrative embodiments used to describe the invention generally address and solve the above-described problems and other problems related to updating firmware in a data processing environment. The illustrative embodiments provide a method, system, and computer program product for updating firmware using a mobile communication device.

Generally, the mobile communication device according to the illustrative embodiments is a mobile device including mobile data communication and data storage capabilities. In a process of performing a firmware update according to an illustrative embodiment, the mobile communication determines whether a firmware version on a given data processing system is out of date, determines whether an update is available, receives the update, facilitates applying the update, reboots the system using the mobile communication device's data storage as a boot medium, or some combination of these and other similarly purposed operations.

The illustrative embodiments are described with respect to certain components only as examples. Such descriptions are not intended to be limiting on the illustrative embodiments. For example, an illustrative embodiment described with respect to a server can be implemented with respect to a data storage component, networking component, peripherals, or sub-components thereof within the scope of the illustrative embodiments.

Furthermore, the illustrative embodiments may be implemented with respect to any type of data, data source, or access to a data source over a data network. Any type of data storage device may provide the data to an embodiment of the invention, either locally at a data processing system or over a data network, within the scope of the invention.

The illustrative embodiments are further described with respect to certain applications only as examples. Such descriptions are not intended to be limiting on the invention. An embodiment of the invention may be implemented with respect to any type of application, such as, for example, applications that are served, the instances of any type of server application, a platform application, a stand-alone application, an administration application, or a combination thereof.

An application, including an application implementing all or part of an embodiment, may further include data objects, code objects, encapsulated instructions, application fragments, services, and other types of resources available in a data processing environment. For example, a Java® object, an Enterprise Java Bean (EJB), a servlet, or an applet may be manifestations of an application with respect to which the invention may be implemented. (Java and all Java-based trademarks and logos are trademarks or registered trademarks of Oracle and/or its affiliates).

An illustrative embodiment may be implemented in hardware, software, or a combination thereof. An illustrative embodiment may further be implemented with respect to any type of data storage resource, such as a physical or virtual data storage device, that may be available in a given data processing system configuration.

The examples in this disclosure are used only for the clarity of the description and are not limiting on the illustrative embodiments. Additional data, operations, actions, tasks, activities, and manipulations will be conceivable from this disclosure and the same are contemplated within the scope of the illustrative embodiments.

The illustrative embodiments are described using specific code, designs, architectures, layouts, schematics, and tools only as examples and are not limiting on the illustrative embodiments. Furthermore, the illustrative embodiments are described in some instances using particular software, tools, and data processing environments only as an example for the clarity of the description. The illustrative embodiments may be used in conjunction with other comparable or similarly purposed structures, systems, applications, or architectures.

Any advantages listed herein are only examples and are not intended to be limiting on the illustrative embodiments. Additional or different advantages may be realized by specific illustrative embodiments. Furthermore, a particular illustrative embodiment may have some, all, or none of the advantages listed above.

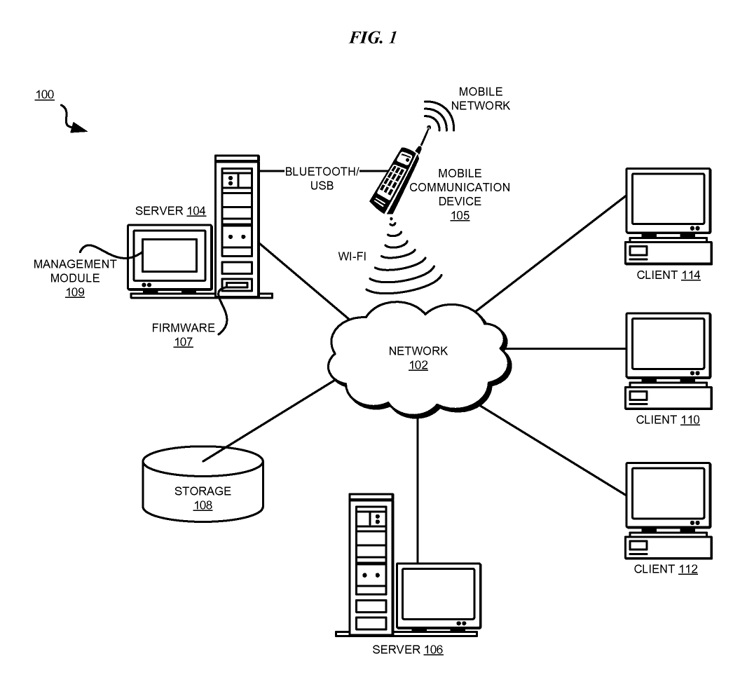

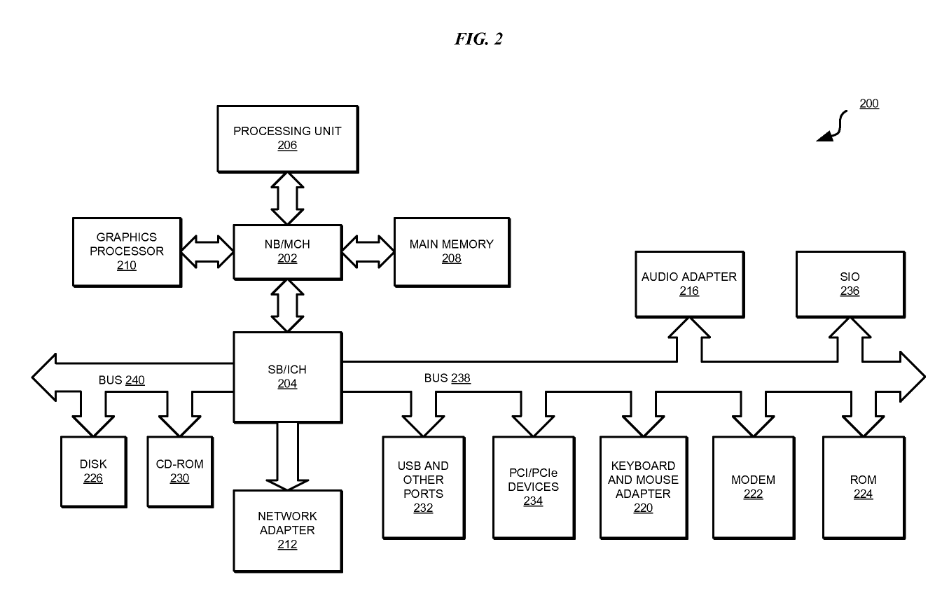

With reference to the figures and in particular with reference to FIGS. 1 and 2, these figures are example diagrams of data processing environments in which illustrative embodiments may be implemented. FIGS. 1 and 2 are only examples and are not intended to assert or imply any limitation with regard to the environments in which different embodiments may be implemented. A particular implementation may make many modifications to the depicted environments based on the following description.

FIG. 1 depicts a pictorial representation of a network of data processing systems in which illustrative embodiments may be implemented. Data processing environment 100 is a network of computers in which the illustrative embodiments may be implemented. Data processing environment 100 includes network 102. Network 102 is the medium used to provide communications links between various devices and computers connected together within data processing environment 100. Network 102 may include connections, such as wire, wireless communication links, or fiber optic cables. Server 104 and server 106 couple to network 102 along with storage unit 108. Software applications may execute on any computer in data processing environment 100.

In addition, clients 110, 112, and 114 couple to network 102. A data processing system, such as server 104 or 106, or client 110, 112, or 114 may contain data and may have software applications or software tools executing thereon.

Mobile communication device 105 can communicate with network 102 using a wireless data communication protocol, with a mobile network using any suitable mobile/cellular data communication technology, with a data processing system using a wireless communication protocol—such as Bluetooth—or over a wired connection with the data processing system—such as over Universal Serial Bus (USB). A data processing system, such as server 104 includes firmware 107 that can be updated using an embodiment. Management module 109 may be a management module for server 104 as described earlier, or may be any other suitable application or interface, such as a command line interface, that can accept commands for program installation, execution, or reboot on server 104.

Servers 104 and 106, storage unit 108, and clients 110, 112, and 114 may couple to network 102 using wired connections, wireless communication protocols, or other suitable data connectivity. Clients 110, 112, and 114 may be, for example, personal computers or network computers.

In the depicted example, server 104 may provide data, such as boot files, operating system images, and applications to clients 110, 112, and 114. Clients 110, 112, and 114 may be clients to server 104 in this example. Clients 110, 112, 114, or some combination thereof, may include their own data, boot files, operating system images, and applications. Data processing environment 100 may include additional servers, clients, and other devices that are not shown.

In the depicted example, data processing environment 100 may be the Internet. Network 102 may represent a collection of networks and gateways that use the Transmission Control Protocol/Internet Protocol (TCP/IP) and other protocols to communicate with one another. At the heart of the Internet is a backbone of data communication links between major nodes or host computers, including thousands of commercial, governmental, educational, and other computer systems that route data and messages. Of course, data processing environment 100 also may be implemented as a number of different types of networks, such as for example, an intranet, a local area network (LAN), or a wide area network (WAN). FIG. 1 is intended as an example, and not as an architectural limitation for the different illustrative embodiments.

Among other uses, data processing environment 100 may be used for implementing a client-server environment in which the illustrative embodiments may be implemented. A client-server environment enables software applications and data to be distributed across a network such that an application functions by using the interactivity between a client data processing system and a server data processing system. Data processing environment 100 may also employ a service oriented architecture where interoperable software components distributed across a network may be packaged together as coherent business applications.

With reference to FIG. 2, this figure depicts a block diagram of a data processing system in which illustrative embodiments may be implemented. Data processing system 200 is an example of a computer, such as server 104 or client 110 in FIG. 1, in which computer usable program code or instructions implementing the processes of the illustrative embodiments may be located for the illustrative embodiments.

In the depicted example, data processing system 200 employs a hub architecture including north bridge and memory controller hub (NB/MCH) 202 and south bridge and input/output (I/O) controller hub (SB/ICH) 204. Processing unit 206, main memory 208, and graphics processor 210 are coupled to north bridge and memory controller hub (NB/MCH) 202. Processing unit 206 may contain one or more processors and may be implemented using one or more heterogeneous processor systems. Graphics processor 210 may be coupled to the NB/MCH through an accelerated graphics port (AGP) in certain implementations.

In the depicted example, local area network (LAN) adapter 212 is coupled to south bridge and I/O controller hub (SB/ICH) 204. Audio adapter 216, keyboard and mouse adapter 220, modem 222, read only memory (ROM) 224, universal serial bus (USB) and other ports 232, and PCI/PCIe devices 234 are coupled to south bridge and I/O controller hub 204 through bus 238. Hard disk drive (HDD) 226 and CD-ROM 230 are coupled to south bridge and I/O controller hub 204 through bus 240. PCI/PCIe devices may include, for example, Ethernet adapters, add-in cards, and PC cards for notebook computers. PCI uses a card bus controller, while PCIe does not. ROM 224 may be, for example, a flash binary input/output system (BIOS). Hard disk drive 226 and CD-ROM 230 may use, for example, an integrated drive electronics (IDE) or serial advanced technology attachment (SATA) interface. A super I/O (SIO) device 236 may be coupled to south bridge and I/O controller hub (SB/ICH) 204.

An operating system runs on processing unit 206. The operating system coordinates and provides control of various components within data processing system 200 in FIG. 2. The operating system may be a commercially available operating system such as Microsoft® Windows® (Microsoft and Windows are trademarks of Microsoft Corporation in the United States, other countries, or both), or Linux® (Linux is a trademark of Linus Torvalds in the United States, other countries, or both). An object oriented programming system, such as the Java™ programming system, may run in conjunction with the operating system and provides calls to the operating system from Java™ programs or applications executing on data processing system 200 (Java and all Java-based trademarks and logos are trademarks or registered trademarks of Oracle and/or its affiliates).

Program instructions for the operating system, the object-oriented programming system, the processes of the illustrative embodiments, and applications or programs are located on storage devices, such as hard disk drive 226, and may be loaded into a memory, such as, for example, main memory 208, read only memory 224, or one or more peripheral devices, for execution by processing unit 206. Program instructions may also be stored permanently in non-volatile memory and either loaded from there or executed in place. For example, the synthesized program according to an embodiment can be stored in non-volatile memory and loaded from there into DRAM.

The hardware in FIGS. 1-2 may vary depending on the implementation. Other internal hardware or peripheral devices, such as flash memory, equivalent non-volatile memory, or optical disk drives and the like, may be used in addition to or in place of the hardware depicted in FIGS. 1-2. In addition, the processes of the illustrative embodiments may be applied to a multiprocessor data processing system.

In some illustrative examples, data processing system 200 may be a personal digital assistant (PDA), which is generally configured with flash memory to provide non-volatile memory for storing operating system files and/or user-generated data. A bus system may comprise one or more buses, such as a system bus, an I/O bus, and a PCI bus. Of course, the bus system may be implemented using any type of communications fabric or architecture that provides for a transfer of data between different components or devices attached to the fabric or architecture.

A communications unit may include one or more devices used to transmit and receive data, such as a modem or a network adapter. A memory may be, for example, main memory 208 or a cache, such as the cache found in north bridge and memory controller hub 202. A processing unit may include one or more processors or CPUs.

The depicted examples in FIGS. 1-2 and above-described examples are not meant to imply architectural limitations. For example, data processing system 200 also may be a tablet computer, laptop computer, or telephone device in addition to taking the form of a PDA.

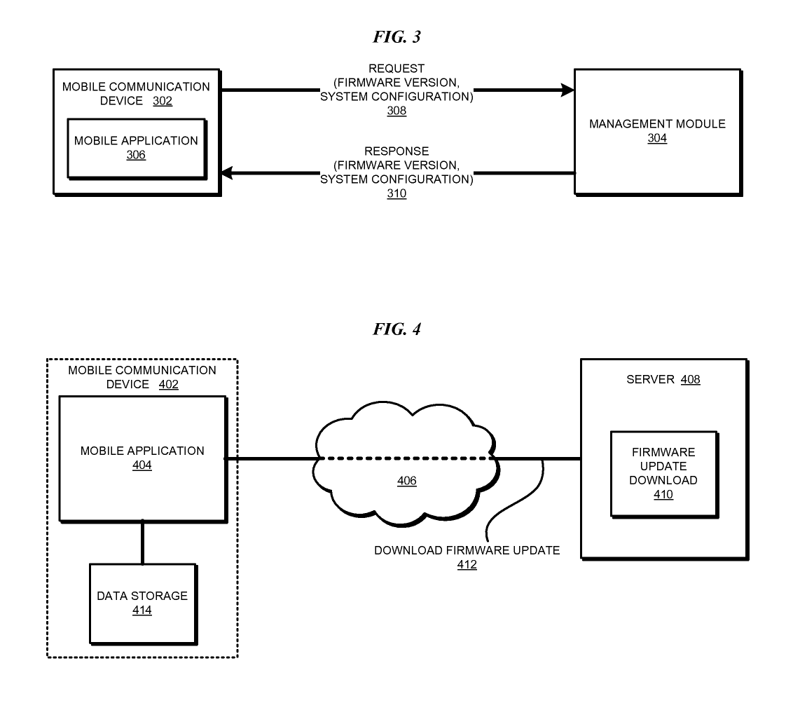

With reference to FIG. 3, this figure depicts an example process of receiving information about a system's firmware using a mobile communication device in accordance with an illustrative embodiment. Mobile communication device 105 in FIG. 1 can be used as mobile communication device 302. Management module 304 is analogous to management module 109 in FIG. 1 or another suitable application or interface as described earlier.

Mobile application 306 is a software application including the characteristics described herein and executing on mobile communication device 302. Mobile application 306 sends request 308 to management module 304. Request 308 conforms to the protocol that management module 304 uses for communicating with other applications. One example of such a protocol is Intelligent Platform management Interface (IPMI).

Request 308 requests at least firmware version information from management module 304. In one embodiment, request 308 requests the data processing system's topology, system configuration, or a combination thereof in addition to the firmware version. A firmware version identifies the firmware and a version of code currently installed thereon.

Mm 304 sends response 310 to mobile application 306. Response 310 includes the requested firmware version. In one embodiment, response 310 includes additional information requested in a corresponding request 308, such as the data processing system's topology or configuration.

With reference to FIG. 4, this figure depicts a block diagram of a process of using a mobile communication device for updating firmware in accordance with an illustrative embodiment. Mobile communication device 402 and mobile application 404 correspond to mobile communication device 302 and mobile application 306 respectively in FIG. 3. Network 406 is analogous to network 102 in FIG. 1.

Server 408 may be any data processing system that is accessible over network 406 and provides data 410 for download. Data 410 is a firmware update for a given firmware, such as the firmware whose version is identified in response 310 in FIG. 3.

Mobile application 404 downloads 412 data 410 from server 408. Data 410 is stored in data storage 414 associated with mobile communication device 402. Data storage 414 is associated with mobile communication device 402 such that data storage 414 can be used as a boot medium when mobile communication device 402 is coupled with a data processing system using a suitable data network, such as USB or Bluetooth.

With reference to FIG. 5, this figure depicts a block diagram of using a mobile communication device for updating firmware in a data processing system in accordance with an illustrative embodiment. Mobile communication device 502 and data storage 504 are analogous to mobile communication device 402 and data storage 414 respectively in FIG. 4. Firmware update 506 is data stored in data storage 504, the data being the update for the firmware downloaded from server 408 in FIG. 4.

Data processing system 508 is a system whose firmware has to be updated. In one embodiment, data processing system 508 is the data processing system on which management module 304 executes and provides the firmware version. Data processing system 508 is coupled with mobile communication device 502 using data coupling 510. Data coupling 510 is any suitable manner of coupling mobile communication device 502 with data processing system 508 such that data storage 504 of mobile communication device 502 appears as boot medium 512 to data processing system 508. When coupled in this manner, data 506 in data storage 504 appears as boot image 514 in boot medium 512 in data processing system 508.

One example of such a data coupling, without implying a limitation there to, is a USB cable connecting mobile communication device 502 to data processing system 508. Depending on the type of mobile communication device 502 and available connectivity at data processing system 508, other methods, protocols, devices, or ports may be suitable to form data coupling 510 and the same are contemplated within the scope of the illustrative embodiments.

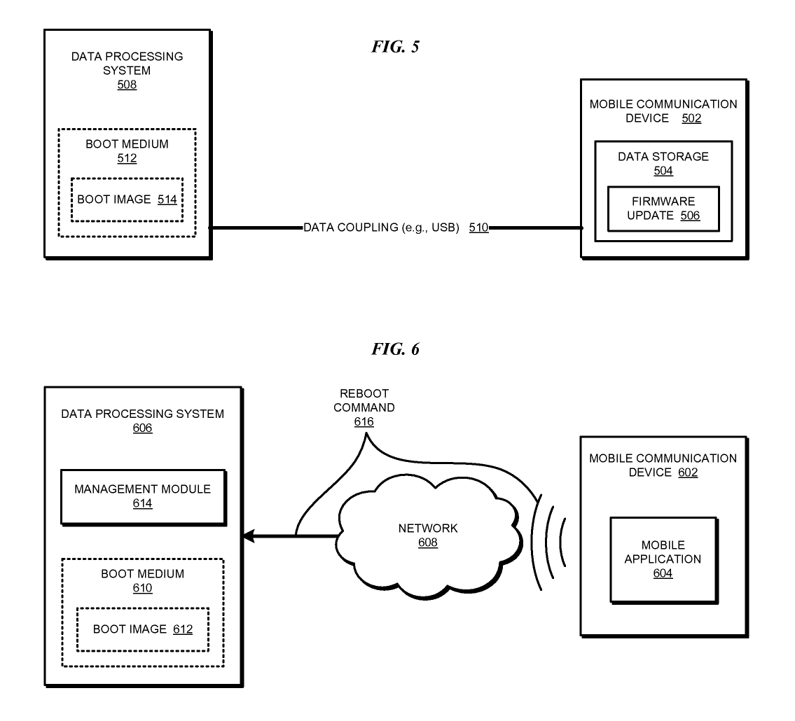

With reference to FIG. 6, this figure depicts a block diagram of applying a firmware update using a mobile communication device in accordance with an illustrative embodiment. Mobile communication device 602 corresponds to mobile communication device 502 in FIG. 5. Mobile application 604 is analogous to mobile application 404 in FIG. 4. Data processing system 606 is the same as data processing system 508 in FIG. 5. Network 608 is similar to network 102 in FIG. 1.

Boot medium 610 and boot image 612 therein correspond to boot medium 512 and boot image 514 respectively, as described in FIG. 5. Data processing system 606 includes management module 614, which is analogous to management module 304 in FIG. 3.

As described above with respect to an embodiment, mobile communication device 602 identifies the firmware version in data processing system 606, downloads a suitable firmware update there for, and couples to data processing system 606 such that the downloaded firmware update appears at data processing system 606 as boot image 612. Recall that boot image 612 is actually data stored on a data storage associated with mobile communication device 602 and appears as boot image 612 on boot medium 610 by virtue of a data coupling between data processing system 606 and mobile communication device 602.

Thereafter, mobile communication device 602 transmits reboot command 616 to data processing system 606. In one embodiment, reboot command 616 is communicated from mobile communication device 602 to network 608 over a wireless data communication link, and from network 608 to data processing system 606 over a wired data communication link. Generally, any suitable wired or wireless data communication links between mobile communication device 602, network 608, and data processing system 606 can be used for communicating reboot command 616 within the scope of the illustrative embodiments.

Mm 614 receives reboot command 616. In one embodiment, management module 614 includes logic to know that reboot command 616 uses boot image 612 for the reboot. In another embodiment, reboot command 616 specifies that the reboot should occur using boot image 612. Management module 614 triggers a reboot of data processing system 606 using reboot command 616.

In one example embodiment, mobile application 604 also provides the installation instructions (not shown in the figure). For example, mobile application 604 not only downloads the firmware update from a server but also any corresponding installation instructions. Mobile application 604, via a user interface display on mobile communication device 602, displays the instructions to an administrator. The administrator determines the timing of reboot command 616 depending on the processes executing on data processing system 606.

In another example embodiment, reboot command 616 is accompanied by installation instructions. Management module 614 displays the installation instructions to the administrator via a user interface associated with data processing system 606. The administrator determines when to execute a reboot of data processing system 606 according to reboot command 616, by taking into consideration the processes executing on data processing system 606, regardless of when mobile communication device 602 transmits reboot command.

These example embodiments describe some of the many ways in which the installation and reboot process can occur using mobile communication device 602. Other ways of presenting the installation instructions and managing the reboot timing will be apparent from this disclosure to those of ordinary skill in the art and the same are contemplated within the scope of the illustrative embodiments.

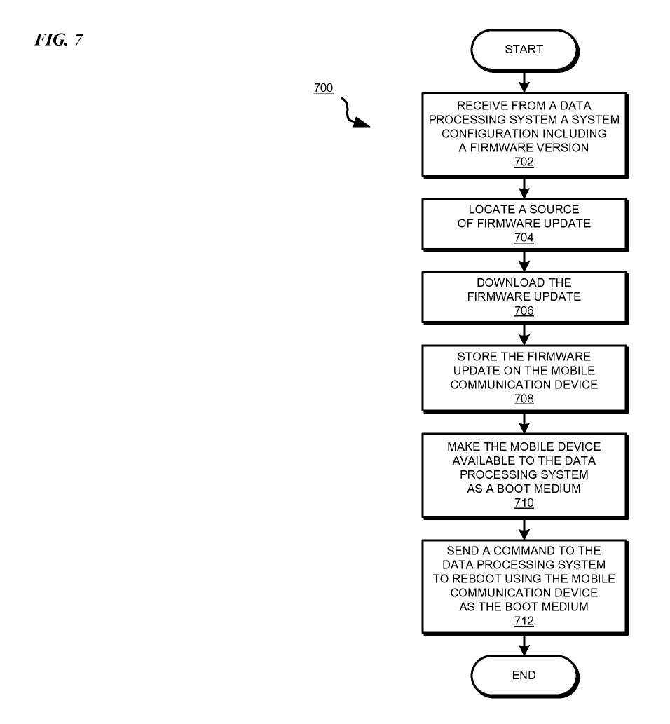

With reference to FIG. 7, this figure depicts a flowchart of a process for updating firmware using a mobile communication device in accordance with an illustrative embodiment. Process 700 may be implemented in a mobile communication device, such as mobile communication device 602 in FIG. 6.

Process 700 begins by receiving from a data processing system, system configuration information including the version of the firmware in the data processing system (step 702). In one embodiment, process 700 may receive only the firmware version in step 702. In another embodiment, the information received in step 702 is responsive to a request. In another embodiment, the information received in step 702 is responsive to detecting a particular mobile device on a network or in the proximity of the data processing system.

Process 700 locates a source of firmware update data (step 704). In one embodiment, the source is a server on the same local network as the data processing system of step 702. In another embodiment, the source is a server on a public network and not accessible to a management module executing on the data processing system of step 702.

Process 700 downloads the firmware update data (step 706). Process 700 stores the firmware update data on the mobile communication device, such as on a data storage associated with the mobile communication device (step 708).

Process 700 makes the mobile communication device available to the data processing system as a boot medium (step 710). Process 700 sends a command to the data processing system to reboot using the mobile communication device as the boot medium (step 712). Process 700 ends thereafter.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

Thus, a computer implemented method, system, and computer program product are provided in the illustrative embodiments for updating firmware using a mobile communication device.

As will be appreciated by one skilled in the art, aspects of the present invention may be embodied as a system, method, or computer program product. Accordingly, aspects of the present invention may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, aspects of the present invention may take the form of a computer program product embodied in one or more computer readable storage device(s) or computer readable media having computer readable program code embodied thereon.

Any combination of one or more computer readable storage device(s) or computer readable media may be utilized. The computer readable medium may be a computer readable signal medium or a computer readable storage medium. A computer readable storage device may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage device would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer readable storage device may be any tangible device or medium that can contain, or store a program for use by or in connection with an instruction execution system, apparatus, or device.

Program code embodied on a computer readable storage device or computer readable medium may be transmitted using any appropriate medium, including but not limited to wireless, wireline, optical fiber cable, RF, etc., or any suitable combination of the foregoing.

Computer program code for carrying out operations for aspects of the present invention may be written in any combination of one or more programming languages, including an object oriented programming language such as Java, Smalltalk, C++ or the like and conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

Aspects of the present invention are described herein with reference to flowchart illustrations and/or block diagrams of methods, apparatus (systems) and computer program products according to embodiments of the invention. It will be understood that each block of the flowchart illustrations and/or block diagrams, and combinations of blocks in the flowchart illustrations and/or block diagrams, can be implemented by computer program instructions. These computer program instructions may be provided to one or more processors of one or more general purpose computers, special purpose computers, or other programmable data processing apparatuses to produce a machine, such that the instructions, which execute via the one or more processors of the computers or other programmable data processing apparatuses, create means for implementing the functions/acts specified in the flowchart and/or block diagram block or blocks.

These computer program instructions may also be stored in one or more computer readable storage devices or computer readable that can direct one or more computers, one or more other programmable data processing apparatuses, or one or more other devices to function in a particular manner, such that the instructions stored in the one or more computer readable storage devices or computer readable medium produce an article of manufacture including instructions which implement the function/act specified in the flowchart and/or block diagram block or blocks.

The computer program instructions may also be loaded onto one or more computers, one or more other programmable data processing apparatuses, or one or more other devices to cause a series of operational steps to be performed on the one or more computers, one or more other programmable data processing apparatuses, or one or more other devices to produce a computer implemented process such that the instructions which execute on the one or more computers, one or more other programmable data processing apparatuses, or one or more other devices provide processes for implementing the functions/acts specified in the flowchart and/or block diagram block or blocks.

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof. The corresponding structures, materials, acts, and equivalents of all means or step plus function elements in the claims below are intended to include any structure, material, or act for performing the function in combination with other claimed elements as specifically claimed. The description of the present invention has been presented for purposes of illustration and description, but is not intended to be exhaustive or limited to the invention in the form disclosed. Many modifications and variations will be apparent to those of ordinary skill in the art without departing from the scope and spirit of the invention. The embodiments were chosen and described in order to best explain the principles of the invention and the practical application, and to enable others of ordinary skill in the art to understand the invention for various embodiments with various modifications as are suited to the particular use contemplated.

What is claimed is:

1. A computer implemented method for updating a firmware using a mobile communication device, the method comprising:
receiving, at the mobile communication device from a data processing system that includes the firmware, a current version information of the firmware;
storing, at the mobile communication device, an update of the firmware on a data storage associated with the mobile communication device; and
instructing, from the mobile communication device, the data processing system to reboot using the update stored on the data storage associated with the mobile communication device.

2. The computer implemented method of claim 1, wherein the instructing further comprises:
transmitting a reboot command from the mobile communication device to the data processing system, the reboot command using the update on the data storage associated with the mobile communication device as the boot image.

3. The computer implemented method of claim 1, wherein the instructing further comprises:
transmitting a reboot command from the mobile communication device to the data processing system, wherein a management module executing in the data processing system recognizes a type of the reboot command and uses the update on the data storage associated with the mobile communication device as the boot image for executing reboot command of the type.

4. The computer implemented method of claim 1, further comprising:
coupling the mobile communication device with the data processing system such that the data storage associated with the mobile communication device becomes available as a boot medium to the data processing system, and such that the update stored on the data storage associated with the mobile communication device becomes available as a boot image for rebooting the data processing system.

5. The computer implemented method of claim 1, further comprising:
locating the source, wherein access from data processing system to the source for downloading the update is not permitted.

6. The computer implemented method of claim 1, further comprising:
performing a lookup at the source for the update of the firmware;
downloading, at the mobile communication device, responsive to the lookup revealing an availability of the update, the update of the firmware from the source.

7. The computer implemented method of claim 1, wherein the receiving is responsive to detecting the mobile communication device on a data network.

8. A computer usable program product comprising a computer usable storage medium including computer usable code for updating a firmware using a mobile communication device, the computer usable code comprising:
computer usable code for receiving, at the mobile communication device from a data processing system that includes the firmware, a current version information of the firmware;
computer usable code for storing, at the mobile communication device, an update of the firmware on a data storage associated with the mobile communication device; and
computer usable code for instructing, from the mobile communication device, the data processing system to reboot using the update stored on the data storage associated with the mobile communication device.

9. The computer usable program product of claim 8, wherein the instructing further comprises:
computer usable code for transmitting a reboot command from the mobile communication device to the data processing system, the reboot command using the update on the data storage associated with the mobile communication device as the boot image.

10. The computer usable program product of claim 8, wherein the instructing further comprises:
computer usable code for transmitting a reboot command from the mobile communication device to the data processing system, wherein a management module executing in the data processing system recognizes a type of the reboot command and uses the update on the data storage associated with the mobile communication device as the boot image for executing reboot command of the type.

11. The computer usable program product of claim 8, further comprising:
computer usable code for coupling the mobile communication device with the data processing system such that the data storage associated with the mobile communication device becomes available as a boot medium to the data processing system, and such that the update stored on the data storage associated with the mobile communication device becomes available as a boot image for rebooting the data processing system.

12. The computer usable program product of claim 8, further comprising:
computer usable code for locating the source, wherein access from data processing system to the source for downloading the update is not permitted.

13. The computer usable program product of claim 8, further comprising:
computer usable code for performing a lookup at the source for the update of the firmware;
computer usable code for downloading, at the mobile communication device, responsive to the lookup revealing an availability of the update, the update of the firmware from the source.

14. The computer usable program product of claim 8, wherein the receiving is responsive to detecting the mobile communication device on a data network.

15. The computer usable program product of claim 8, wherein the computer usable code is stored in a computer readable storage medium in a data processing system, and wherein the computer usable code is transferred over a network from a remote data processing system.

16. The computer usable program product of claim 8, wherein the computer usable code is stored in a computer readable storage medium in a server data processing system, and wherein the computer usable code is downloaded over a network to a remote data processing system for use in a computer readable storage medium associated with the remote data processing system.

17. A data processing system for updating a firmware using a mobile communication device, the data processing system comprising:
a storage device including a storage medium, wherein the storage device stores computer usable program code; and
a processor, wherein the processor executes the computer usable program code, and wherein the computer usable program code comprises:
computer usable code for receiving, at the mobile communication device from a data processing system that includes the firmware, a current version information of the firmware;
computer usable code for storing, at the mobile communication device, an update of the firmware on a data storage associated with the mobile communication device; and
computer usable code for instructing, from the mobile communication device, the data processing system to reboot using the update stored on the data storage associated with the mobile communication device.

18. The data processing system of claim 17, wherein the instructing further comprises:
computer usable code for transmitting a reboot command from the mobile communication device to the data processing system, the reboot command using the update on the data storage associated with the mobile communication device as the boot image.

19. The data processing system of claim 17, wherein the instructing further comprises:
computer usable code for transmitting a reboot command from the mobile communication device to the data processing system, wherein a management module executing in the data processing system recognizes a type of the reboot command and uses the update on the data storage associated with the mobile communication device as the boot image for executing reboot command of the type.

20. The data processing system of claim 17, further comprising:
computer usable code for coupling the mobile communication device with the data processing system such that the data storage associated with the mobile communication device becomes available as a boot medium to the data processing system, and such that the update stored on the data storage associated with the mobile communication device becomes available as a boot image for rebooting the data processing system.
